(19) United States
(12) Patent Application Publication
(10) Pub. No.: US 2023/0399516 A1
(43) Pub. Date: Dec. 14, 2023

(54) RADAR TRANSMISSIVE PIGMENTS, COATINGS, FILMS, ARTICLES, METHOD OF MANUFACTURE THEREOF, AND METHODS OF USE THEREOF

(71) Applicant: PPG Industries Ohio, Inc., Cleveland, OH (US)

(72) Inventors: Scott J. Moravek, Mars, PA (US); Eldon L. Decker, Gibsonia, PA (US); Calum H. Munro, Gibsonia, PA (US); David R. Fenn, Allison Park, PA (US); Nicolas B. Duarte, Allison Park, PA (US); Daniel Connor, Evans City, PA (US); Hao Sun, Pittsburgh, PA (US)

(73) Assignee: PPG Industries Ohio, Inc., Cleveland, OH (US)

(21) Appl. No.: 18/004,693

(22) PCT Filed: Jul. 8, 2021
(86) PCT No.: PCT/US2021/040877

§ 371 Date: Jan. 9, 2023

Related U.S. Application Data
(60) Provisional application No. 63/142,091, filed on Jan. 27, 2021.
(60) Provisional application No. 63/090,394, filed on Oct. 12, 2020.
(60) Provisional application No. 63/049,670, filed on Jul. 9, 2020.

(51) Int. Cl. C09C 1/00; C09C 3/06; C09D 5/02

(52) U.S. Cl. CPC C09C 1/0078; C09C 3/066; C09D 5/028; C01P 2004/54; C01P 2006/60; C01P 2004/64

(57) ABSTRACT

Radar transmissive pigments, coatings, films, articles, method of manufacture thereof, and methods of use thereof are provided. The pigment comprises a non-conductive composite. The non-conductive composite comprises a semiconductor and/or a dielectric, and a metal dispersed in and/or on the semiconductor and/or dielectric. The pigment has an aspect ratio of at least 5 as measured by the Aspect Ratio Test.

### CROSS-REFERENCE TO RELATED APPLICATIONS

The present application claims priority to U.S. Provisional Application No. 63/142,091, titled “RADAR TRANSMISSIVE PIGMENTS AND THEIR USE”, filed Jan. 27, 2021, U.S. Provisional Application No. 63/090,394, titled “RADAR TRANSMISSIVE PIGMENTS AND THEIR USE”, filed Oct. 12, 2020, and U.S. Provisional Application No. 63/049,670, titled “RADAR TRANSMISSIVE PIGMENTS AND COATINGS”, filed Jul. 9, 2020. The contents of each are hereby incorporated by reference into this specification.

### FIELD

The present disclosure relates to radar transmissive pigments comprising a non-conductive composite comprising a metal and a semiconductor and/or dielectric (SCD) and coatings, films, and articles comprising such pigments. The present disclosure also relates to methods of manufacture of pigments, coatings, films, and articles and methods of use of pigments, coatings, films, and articles.

### BACKGROUND

The use of radar is becoming ubiquitous in modern transportation including passenger vehicles with advanced driver assistance systems (ADAS), such as adaptive cruise control (ACC), automatic breaking, and the like. The use of radar will likely increase as higher levels of autonomous driving are implemented. Radar performance can be hindered by unwanted radar signal loss, which may result from the use of metallic pigments, such as aluminum flakes, commonly used in coatings to achieve a certain luster, sparkle, and/or a metallic color. Coatings, films, and articles of manufacture that minimize interference with radar while providing the desired appearance are desired.

### SUMMARY

The present disclosure relates to a pigment comprising a non-conductive composite. The non-conductive composite comprises a semiconductor and/or a dielectric, and a metal dispersed in and/or on the semiconductor and/or dielectric. The pigment has an aspect ratio of at least 5, wherein the aspect ratio is an average lateral size of the pigment divided by an average thickness of the pigment.

The present disclosure also relates to coatings, films, and articles comprising a pigment comprising a non-conductive composite. The non-conductive composite comprises a semiconductor and/or a dielectric, and a metal dispersed in and/or on the semiconductor and/or dielectric. The pigment has an aspect ratio of at least 5 as measured by the Aspect Ratio Test.

It is understood that the inventions described in this specification are not limited to the examples summarized in this Summary. Various other aspects are described and exemplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 illustrates an image of a non-conductive composite layer formed of indium deposited onto a clear UV cured primer coating observed by an SEM using the top-down FE-SEM method; and

FIG. 2 illustrates a schematic image of a non-conductive composite layer formed of aluminum dispersed within a silicon SCD.

The exemplifications set out herein illustrate certain non-limiting embodiments, in one form, and such exemplifications are not to be construed as limiting the scope of the appended claims in any manner.

### DETAILED DESCRIPTION

Metallic pigments, such as aluminum flakes, are commonly used in coatings as effect pigments to achieve a desirable luster, sparkle, and/or a metallic color. However, the use of metallic pigments in a coating can lead to a loss in radar transmission through the coating. Additionally, removal of the metallic pigment can increase radar transmission through the coating at the expense of the desirable luster, sparkle, and/or metallic color. Therefore, the present disclosure provides a pigment that can achieve a desirable luster, sparkle, and/or metallic color with minimal, if any, radar transmission loss through a coating comprising the pigment. The pigment according to the present disclosure comprises a non-conductive composite. The non-conductive composite comprises a semiconductive material (a “semiconductor”) and/or a dielectric material (a “dielectric”) in which the metal can be dispersed.

The pigments may also have a lateral surface that is smooth and planar, like commercially available vacuum metalized pigment (VMP) or physical vapor deposition (PVD) aluminum flakes, as opposed to rougher, corn flake-type aluminum flake pigments as described in “Metallic Effect Pigments,” Peter ViBling, 2006 Vincentz Network GmbH, ISBN 3-87870-171-3, which is hereby incorporated by reference.

As used herein, “pigment” refers to an insoluble particle that provides reflective characteristics in the visible wavelengths of the electromagnetic spectrum. As used herein, the term “visible” refers to the visible wavelengths of the electromagnetic spectrum. For example, the visible wavelengths may be a range of 400 nm to 700 nm. The pigments according to the present disclosure can provide visible light reflective characteristics to a composition that incorporates the pigment. As used herein, “insoluble” in reference to a pigment of the present disclosure means the pigment (including the components that comprise the pigment) is insoluble in water and the typical solvents, such as organic solvents, used in coating compositions, film compositions, and article of manufacture compositions. Solubility may be tested, for example, by making a 1 weight percent (wt %) mixture of the solute (e.g., pigment particle) in the desired medium based on the total weight of mixture, such as water and/or organic solvent(s), at ambient temperature and observing if the pigment dissolves into the desired medium or otherwise remains as a separate phase. As used herein, “ambient temperature” refers to a temperature of 23° C.+/−3° C. Thus, when formulating a coating, a film, or an article incorporating the pigment according to the present disclosure, solvent(s) in which the pigment is insoluble may be chosen.

In addition, the pigment according to the present disclosure may be resistant to melting, such as, for example, when formulating a coating, a film, and/or article in a softened or molten state. As used herein, “resistant to melting” when used in reference to pigment means that the pigment will substantially, if not completely, retain its solid form during heating (e.g., at temperatures of at least 140 degrees Celsius), such as heating used during cure of a coating composition or the production of a film or article. For example, the non-conductive composite may be substantially free of or completely free of a thermoplastic resin, such as, for example, poly(methyl methacrylate), polycarbonate, and polyvinyl butyral, as a thermoplastic may be deformed and/or degraded (e.g., dissolve) when incorporated into a coating, film, and/or article.

The non-conductive composite may be substantially free (e.g., 1% by weight or less) of or completely free of (e.g., 0.01% by weight or less) a material that is predominantly amorphous carbon, such as, for example, diamond-like carbon, as amorphous carbon may not have desirable wetting, cohesion in a coating, film, and/or article, and/or a desirable color.

The non-conductive composite comprises a semiconductor and/or a dielectric (“SCD”). Thus, while these non-conductive composites are described herein as an SCD, either one of or both of a semiconductor and a dielectric can be present in the non-conductive composite. The medium (e.g., SCD) in which the metal is dispersed may also be referred to herein as the matrix. The metal and matrix can form a non-homogenous mixture that can be used to form the pigment. As used herein, “non-homogenous” means that the metal remains phase segregated within the matrix and is not solubilized in the matrix. The metal can be dispersed uniformly or non-uniformly throughout the matrix.

The amount of metal used in the non-conductive composite in relation to the matrix can be selected to achieve a desired level of visible reflectance for the pigment and/or coating, film, and/or article incorporating the pigment. The amount of metal in the non-conductive composite should also be selected so that the metal will not be soluble in the matrix and/or on the matrix. For example, the metal may be present in an amount in a range of 1 wt % to 50 wt % based on the total weight of the non-conductive composite, such as, for example, 5 wt % to 25 wt % or 10 wt % to 15 wt %, all based on the total weight of the non-conductive composite. The desired level of visual reflectance of the pigment according to the present disclosure can typically be an average reflectance of at least 60% across the visible wavelengths, such as, for example, at least 70% across the visible wavelengths or at least 80% across the visible wavelengths, all measured according to the Visible Reflectance Test. As used herein, the “Visible Reflectance Test” is a measurement using an integrating sphere spectrophotometer, such as an X-Rite Ci7800 spectrophotometer, that averages the reflectance values over the visible wavelengths 10 nm steps for both the specular component included (SCI) mode and the specular excluded (SCE) mode, and then subtracts the average reflectance in the SCE mode from the average reflectance in the SCI mode to provide the visible reflectance value.

The pigment according to the present disclosure can be passivated to inhibit undesired chemical interactions of the pigment with the coating, film, and/or article incorporating the pigment. For example, the pigment according to the present disclosure can be passivated by treatment with an organic acid and/or encapsulated with a material. For example, the pigment according to the present disclosure can be encapsulated in an organic, inorganic, or organic-inorganic hybrid material prior to incorporation into the matrix.

The semiconductor of the non-conductive composite can comprise, for example, silicon, germanium, silicon carbide, boron nitride, aluminum nitride, gallium nitride, silicon nitride, gallium arsenide, indium phosphide, indium nitride, indium arsenide, indium antimonide, zinc oxide, zinc sulfide, zinc telluride, tin sulfide, bismuth sulfide, nickel oxide, boron phosphide, titanium dioxide, barium titanate, iron oxide, doped version thereof (i.e., an addition of a dopant, such as, for example, boron, aluminum, gallium, indium, phosphorous, arsenic, antimony, germanium, nitrogen, at a weight percentage of 0.01% or less), alloyed versions of thereof, other semiconductors, or combinations thereof. For example, the non-conductive composite can comprise silicon.

The dielectric of the non-conductive composite can comprise solid insulator materials (e.g., silicon dioxide), ceramics (e.g., aluminum oxide, yttrium oxide, yttria alumina garnet (YAG), neodymium-doped YAG (Nd:YAG)), glass (e.g., borosilicate glass, soda lime silicate glass, phosphate glass), organic materials, doped versions thereof, other dielectrics, or combinations thereof. The organic material can comprise, for example, acrylics, alkyds, chlorinated polyether, diallyl phthalate, epoxies, epoxy-polyamid, phenolics, polyamide, polyimides, polyesters (e.g., PET), polyethylene, polymethyl methacrylate, polystyrene, polyurethanes, polyvinyl butyral, polyvinyl chloride (PVC), copolymer of PVC and vinyl, acetate, polyvinyl formal, polyvinylidene fluoride, polyxylylenes, silicones, nylons and co-polymers of nylons, polyamide-polymide, polyalkene, polytetrafluoroethylene, other polymers, or combinations thereof. If the dielectric comprises organic materials, the organic materials are selected such that the pigment formed therefrom is resistant to melting and/or resistant to changes in dimension or physical properties upon incorporation into a coating, film, and/or article formulation. For example, the organic material can be insoluble, such as, for example, by crosslinking or having inherent insolubility based on the chemical structure of the polymer. A crosslinked polymer that can be insoluble can be obtained from the reaction of multifunctional acrylates and/or methacrylates. An example of an insoluble but not crosslinked polymer can comprise poly(ethylene terephthalate), where many common solvents may not dissolve the polymer. Additional examples of dielectrics that comprise organic materials can be found in Materials and Processes for Electron Devices (National Research Council. 1972. Materials and Processes for Electron Devices. Washington, DC: The National Academies Press, p. 218, https://doi.org/10.17226/21493), which is hereby incorporated by reference.

The metal can comprise, for example, aluminum, silver, copper, indium, tin, nickel, titanium, gold, iron, alloys thereof, or combinations thereof. The metal can be in particulate form and can have an average particle size in a range of 0.5 nm to 100 nm, such as, for example, 1 nm to 10 nm as measured by a transmission electron microscope (TEM). The metal can be in particulate form and can have an average particle size less than or equal to 20 nm as measured by TEM.

The amount of the metal relative to the SCD in the non-conductive composite can affect the electrical resistivity of the non-conductive composite and a ratio of the SCD to the metal can be selected to achieve a desired electrical resistivity. For example, the non-conductive composite can comprise an SCD to metal weight ratio in a range of 1:1 to 9:1, such as, for example, 2:1 to 8:1, 3:1 to 5:1, or greater than 3:1 to less than 5:1. For example, the non-conductive composite can comprise an SCD to metal weight ratio of 4:1.

The non-conductive composite can comprise a metal in a semiconductor matrix, such as, for example, the metal can comprise aluminum and the SCD can comprise silicon. The non-conductive composite can comprise aluminum nanoscale domains (e.g., particles having an average particle size in a range of 1 nm to 1000 nm) inside a silicon matrix. The non-conductive composite can comprise a silicon to aluminum weight ratio in a range of 1:1 to 9:1, such as, for example, 2:1 to 8:1, 3:1 to 5:1, or greater than 3:1 to less than 5:1. For example, the non-conductive composite can comprise a silicon to aluminum weight ratio of 4:1.

The pigment and/or non-conductive composite can be formed according to various methods. The pigment according to the present disclosure can be manufactured by mixing the metal and the SCD to form a mixture and depositing the mixture to form the non-conductive composite. In certain examples, the SCD (e.g., matrix) can be deposited on a substrate first and the metal can be added to the matrix thereafter. The metal could be added, for example, as discrete particles, as a layer in a predetermined pattern, or as a continuous layer that may be subsequently processed in part to create regions of metal that are not connected and are separated from each other by the SCD, air, or other non-conductive material (e.g., phase-separate regions, islands). For example, selective ablation of the continuous layer can be used to separate the metal. Thin film patterning methods can be used on the continuous layer to separate the metal, such as, for example, lithography for liftoff or etching. Thermal treatment can be used on the continuous layer to cause the metal layer to de-wet and bead on the matrix or diffuse into the matrix, causing formation of “islands” when the heat is removed. Alternating layers of SCD and metal could also be used. The metal may be deposited on a temporary surface and then the SCD can be deposited thereon and processed in any of the above-described methods, after which the temporary surface is removed. Regardless of the method used, the metal should form phase-separated regions on and/or inside the matrix.

The non-conductive composite can be formed by: depositing the metal and the SCD onto a support utilizing sputtering to form a non-conductive composite layer, mixing the metal and the SCD to form a non-conductive composite layer, and/or depositing the SCD to form a layer of SCD and adding the metal to the layer of SCD to form a non-conductive composite layer. In examples where the metal is in particulate form, the metal can be applied in a predetermined pattern as a non-continuous layer and/or in a continuous layer to the layer of SCD. If the metal is applied in a continuous layer, the non-conductive composite can be further processed to create discrete islands of the metal (e.g., etching, ablation).

In various examples, the non-conductive composite can be formed by PVD, such as, for example, vacuum sputtering from sputtering targets containing the desired composition of the deposited layer. For example, the conductive composite may be formed by co-sputtering utilizing at least two targets, a first target comprising the metal and a second target comprising the SCD. In various examples, a sputtering target may be a composite target have both the metal and the SCD. The non-conductive composite can be produced in a process similar to the process described in H.-C. Tung, S. S. Yang, L. Chang, “Deposition and characterization of silicon-aluminum non-conductive vacuum metallization coatings,” Materials Letters 131(2014) 161-163, which is hereby incorporated by reference herein.

The non-conductive composite can be deposited by PVD directly onto the support, a release layer that has been applied to the support, or to a soluble film that has been applied to the support. The support can comprise a moving web (e.g., a polypropylene film) or drum. The non-conductive composite can be removed from the support using an air knife assembly. In examples comprising the release layer or soluble film, the release layer or soluble film can be dissolved by treatment or immersion in solvent to release the non-conductive composite from the support. The process of using a release layer or a soluble film to produce PVD aluminum pigments is described in U.S. Pat. No. 6,317,947, Japanese Patent No. JP10152625, U.S. Patent Publication No. 2015/290713, and “PVD Aluminum Pigments: Superior Brilliance for Coatings & Graphic Arts,” Paint & Coatings Industry, Jun. 1, 2000, all of which are hereby incorporated by reference herein.

The non-conductive composition can be collected, for example, via a vacuum into a collection container. The collected non-conductive composition can be loose when collected and can then be processed to the appropriate size and/or shape (e.g., broken up, ground, milled, or the like, or a combination thereof). For example, the collected non-conductive composite can be milled into a powder using an ultra-centrifugal mill. The powder can then be passed through sieves to separate the final pigments into a desired particle size distribution, such as, for example, a desired average lateral size and average thickness.

The non-conductive composite can be frangible; that is, capable of being broken up, ground, milled, or the like, or combinations thereof. Thus, the non-conductive composite can be formed into a desired particle size and/or aspect ratio. While not being bound to any particular mechanism, the inventors believe achieving an aspect ratio of at least 5 can facilitate a desirable luster, sparkle, and/or metallic color in the pigment and/or a coating, film, and/or article in which the pigment is incorporated. The luster may be observed visually with the naked eye.

The pigment has an aspect ratio of at least 5 as measured by the Aspect Ratio Test described below. For example, the pigment can comprise an aspect ratio of at least at least 10, at least 50, at least 100, at least 500, or at least 1000 as measured by the Aspect Ratio Test. The aspect ratio of the pigment can affect the luster, sparkle, and/or metallic color of the pigment, and/or a coating, film, and/or article incorporating the pigment according to the present disclosure.

As used herein, the “Aspect Ratio Test” is a measurement of the ratio of the average lateral size of the pigment (as measured by the Lateral Size Test) divided by the average thickness of the pigment (as measured by the Thickness Test). As used herein, “aspect ratio” refers to the measurement as made by the Aspect Ratio Test. In the Lateral Size Test, the average lateral size of the pigment is measured from an optical microscopy image or images of a statistically relevant sampling of the pigment particles. This is accomplished by measuring the average of the minimum Feret diameter and the maximum Feret diameter of the lateral view for each individual pigment particle. Then, the average sizes for all of the particles are averaged over a statistically relevant sampling of the pigment particles. In addition to the average lateral size, the standard deviation and the range of the lateral particle size can be obtained. In the Thickness Test, the average thickness of the pigment is measured from a TEM for a thickness of less than 5 microns or an optical microscope for a thickness of at least 5 microns. The average thickness of the pigment is measured over a statistically relevant sampling of the pigment particles.

The pigment according to the present disclosure can comprise an average lateral size in a range of 5 microns to 150 microns, such as, for example, 5 microns to 100 microns, 40 microns to 80 microns, 30 microns to 60 microns, 20 microns to 50 microns, 20 microns to 30 microns, 10 microns to 40 microns, 5 microns to 25 microns, or 15 microns to 30 microns as measured by the Lateral Size Test. For example, the pigment according to the present disclosure can comprise an average lateral size of 5 to 25 microns as measured by the Lateral Size Test. The pigment can comprise an average thickness of 20 microns or less, such as, for example, 10 microns or less, or microns or less as measured by the Thickness Test. The pigment can comprise an average thickness of in a range of 1 nm to 20 microns, such as, for example, 1 nm to 5 microns, 0.2 microns to 10 microns, 0.4 microns to 2 microns, 0.5 micron to 1 micron, or 0.5 micron to 5 microns as measured by the Thickness Test. A pigment comprising a significantly larger average thickness than 20 microns may cause a roughening of the surface of a coating, film, and/or articles incorporating the pigment, that can cause a reduction in the gloss of the coating, film, and/or article. Thicker pigments may be desirable in certain applications, such as, for example, for coating layers applied at a thickness of greater than 50 microns and/or in applications wherein a “roughened” or reduced gloss appearance is desired.

The pigment can comprise the non-conductive composite and optionally other additives. For example, the pigment according to the present disclosure can be coated with organic-inorganic coatings, such as, for example, polymer alkoxide composition and an acid functional organosiloxane polyol composition or sol-gel coatings. An example of a polymer alkoxide composite is described with reference to organoalkoxysilane compositions in U.S. Patent Publication US2006/0247348 and an acid functional organosiloxane polyol in U.S. Patent Publication No. 2006/247405, both of which are hereby incorporated by reference. An example of sol-gel coatings (organic or inorganic) are generally described in D. Wang, Gordon P. Bierwagen, Progress in Organic Coatings 64 (2009) 327-338, and in Handbook of Sol-gel Science and Technology: Applications of Sol-gel Technology, Sumio Sakka (ed.), Kluwer Academic Publishers, 2005, ISBN 9781402079689, which is hereby incorporated by reference.

The pigments according to the present disclosure can comprise a surface functionality that imparts a property to the pigment. For example, the surface functionality can facilitate incorporation or dispersion of the pigment into a carrier, such as the coating, film, and/or article formulation that gives a desired visual effect, affects rheology, and the like. The pigment may have an applied coating with additional functionality, such as, for example, acid functionality to facilitate dispersion of the pigment into a water borne coating. For example, the applied coating may have ester, ether, ketone, urethane, aromaticity, epoxy, or hydroxy (or adducts thereof) linkages or groups to facilitate dispersion of the pigment into a solvent-borne coating or a powder coating. The applied coating may have ester, ether, urethane, vinyl, ethylene, propylene, olefin, amide, acrylate, or carbonate (or adducts thereof) linkages to facilitate incorporation of the pigment into a composition from which a film is made. The applied coating may have carbonate, propylene, amide, ester, urethane, or olefin (or adducts thereof) linkages to facilitate dispersion of the pigment into a composition from which an article is made. Surface functionality may also be introduced through the SCD, such as, for example, by using a silane semiconductor having the desired functionality.

Surface functionality can affect the rheological properties of the pigment, such as to facilitate a desired alignment of the pigment in a coating layer, film, and/or article in which the pigment is incorporated. Alignment of the pigment in a coating, film, and/or article can optimize the color appearance of the coating, film, and/or article while minimizing radar loss by achieving the desired color while minimizing the amount of pigment in the coating, film, and/or article.

The pigment according to the present disclosure may have an inorganic composition and/or functionality that facilitates incorporation or dispersion of the pigments into a carrier. For example, the pigment can comprise species selected to interact with the carrier, such as the coating, film, and/or article formulation, such as by chemical bonding or inter-molecular attractive forces like polar interactions. While one of ordinary skill in the art upon reading the present disclosure would recognize there are numerous ways to incorporate such interactions of the pigment and carrier, some examples include selection of a metal that interacts with organic functional groups, such as, for example, the interaction of zinc with sulfur species such as thiol, or the selection of a metal that interacts with acids, such as, for example, the interaction of tin with carboxylic acid. The pigment can include organic-inorganic compounds to facilitate incorporation or dispersion of the pigments into a coating, film, and/or article formulation, such as, for example, alkoxysilanes of the structure (R₁)ₓ—Si—(OR₂)_{y}, where “x” can be in a range of 1 to 3, “y” can be in a range of 1 to 3, and the sum of “x” and “y” can be 4. R₁ can include any organic functionality, including those described above. R₂ can be an alkyl group having a range of 1 to 10 carbons, such as, for example, 1-3 carbons.

As used herein “non-conductive” in reference to the composite and pigment of the present disclosure, means the composite and/or pigment has no or low electrical conductivity. For example, the non-conductive composite and pigment according to the present disclosure can comprise an electrical resistivity of at least 1 Ohm cm as measured according to a four-point probe (e.g., Quatek 5601Y sheet resistivity meter) at ambient temperature, such as, for example, at least 50 Ohm cm as measured according to a four-point probe at ambient temperature. The four-point probe measurement can be performed according to F. M. Smitts, “Measurement of sheet resistivities with four-point probe”, The Bell System Technical Journal, May 1958, 711-718, which is hereby incorporated by reference. The sample size for utilizing the four-point probe measurement can be an at least 1 inch by 1 inch rectangular sample.

Electrical resistivity may be difficult to measure on various pigments and non-conductive composites according to the present disclosure due to the particle size of the pigment and/or non-conductive composite. Accordingly, electrical resistivity of the non-conductive composite and/or pigment can be measured prior to achieving the desired particle size and/or shape. For example, electrical resistivity can be measured following creation of a layer of the non-conductive composite, such as, for example, on a temporary substrate, but before the layer of non-conductive composite is processed to the desired size and/or shape of the pigment. While this measurement of electrical resistivity can be performed on the layer of non-conductive composite, it is understood that the resistivity of the resulting non-conductive composite and pigment after being processed to the desired size and/or shape would have substantially the same electrical resistivity as that of the layer of the non-conductive composite.

The pigment according to the present disclosure can provide a desirable luster, sparkle, and/or metallic color, and because the pigment is non-conductive, the pigment's reduction of radar transmission is minimized as compared to previous pigments that wholly incorporated electrically conductive metals, such as, for example, aluminum flake, copper flake, silver flake, silver-coated copper flake, nickel flake, or other metallic flakes. These previous electrically conductive pigments had an electrical resistivity significantly lower than the pigments according to present disclosure, such as, for example, 7 orders of magnitude lower (such as 10⁻⁶ Ohm cm), which can result in a high radar loss. The pigment according to the present disclosure may comprise electrically conductive materials, such as metals, but when incorporated into the matrix or deposited onto the SCD, the resulting composite and pigments can be non-conductive because the electrically conductive regions within the non-conductive composite are predominantly not connected and can be separated by the SCD, air, or other non-conductive material. Because the pigment according to the present disclosure is non-conductive, the pigment can enable the efficient transmission of electromagnetic radiation, including radar frequency wavelengths. For example, the pigments according to the present disclosure and/or films, coatings, and/or articles that incorporate the pigment can enable efficient transmission of electromagnetic radiation in a wavelength in a range of 1 GHz to 300 GHz, such as, for example, 1 GHz to 100 GHz or 76 GHz to 81 GHz. The 76 GHz to 81 GHz wavelength range can be utilized for automotive radar and other radar applications. The pigments according to the present disclosure, and/or films, coatings, and/or articles that incorporate the pigment can enable the efficient transmission (e.g., are transparent to) of electromagnetic radiation at a wavelength frequency of 24 GHz and/or 77 GHz.

Coating compositions and coating layers derived therefrom can comprise the pigment according to the present disclosure. For example, the coating composition can be an automotive original equipment manufacturer coating composition, an automotive refinish coating composition, an industrial coating composition, an architectural coating composition, a coil coating composition, a packaging coating composition, a marine coating composition, an aerospace coating composition, a consumer electronic coating composition, or the like, or combinations thereof. For example, the coating composition can be applied to an automotive part, such as, for example, a bumper fascia, mirror housings, a fender, a hood, a trunk, a door, or the like, or an aerospace part, such as, for example, a nose cone, a radome, or the like.

The coating composition can comprise the pigment according to the present disclosure and a film-forming resin. The film-forming resin can include a resin that can form a self-supporting continuous film upon removal of any diluents or carriers during physical drying and/or cure at ambient or elevated temperature. “Film-forming resin” as used herein refers to resins that are self-crosslinking, resins that are crosslinked by reaction with a crosslinker, forming a solid film by solvent evaporation, mixtures thereof, or the like. The term “film-forming resin” can refer collectively to both a resin and crosslinker(s) therefor.

The film-forming resin can comprise at least one of a thermosetting film-forming resin and/or a thermoplastic film-forming resin. As used herein, the term “thermosetting” refers to resins that “set” irreversibly upon curing or crosslinking, where the polymer chains of the polymeric components are joined together by covalent bonds, which are often induced, for example, by heat or radiation. In various examples, curing or a crosslinking reaction can be carried out under ambient conditions. Once cured or crosslinked, a thermosetting film-forming resin may not melt upon the application of heat and can be insoluble in conventional solvents. As used herein, the term “thermoplastic” refers to resins that include polymeric components that are not joined by covalent bonds and thereby can undergo liquid flow upon heating and are soluble in conventional solvents.

Thermosetting coating compositions may include a crosslinking agent that may be selected from, for example, aminoplasts, polyisocyanates (including blocked isocyanates), polyepoxides, beta-hydroxyalkylamides, polyacids, anhydrides, organometallic acid-functional materials, polyamines, polyamides, and mixtures of any of the foregoing.

A film-forming resin may have functional groups that are reactive with the crosslinking agent. The film-forming resin in the coatings described herein may be selected from any of a variety of polymers well known in the art. The film-forming resin may be selected from, for example, acrylic polymers, epoxy, polyester polymers, polyurethane polymers, polyamide polymers, polyether polymers, polysiloxane polymers, copolymers thereof, and mixtures thereof. Generally, these polymers may be any polymers of these types made by any method known to those skilled in the art. The functional groups on the film-forming resin may be selected from any of a variety of reactive functional groups, including, for example, carboxylic acid groups, amine groups, epoxide groups, hydroxyl groups, thiol groups, carbamate groups, amide groups, urea groups, isocyanate groups (including blocked isocyanate groups), mercaptan groups, or combinations thereof.

A coating composition can comprise the pigments according to the present disclosure in an amount, for example, in a range of 0.5 volume % (vol %)-50 vol %, such as, for example, 2 vol %-25 vol %, based on total volume of a coating layer formed from the coating composition.

The coating compositions and coating layer formed therefrom can comprise other additives and other pigments than those of the present disclosure. The additives can comprise plasticizers, abrasion-resistant particles, film-strengthening particles, flow control agents, thixotropic agents, rheology modifiers, cellulose acetate butyrate, catalysts, antioxidants, biocides, defoamers, surfactants, wetting agents, dispersing aids, adhesion promoters, clays, hindered amine light stabilizers, ultraviolet (UV) light absorbers and stabilizers, stabilizing agents, fillers, organic cosolvents, reactive diluents, grind vehicles, and other customary auxiliaries, or combinations thereof.

The coating composition can be formulated as a solvent-based composition, a water-based composition, or a 100% solid (i.e. non-volatile) composition that does not comprise a volatile solvent or aqueous carrier. The coating composition can be a liquid at a temperature of −10° C. or greater, such as, for example, 0° C. or greater, 10° C. or greater, 30° C. or greater, 40° C. or greater, or 50° C. or greater. The coating composition can be a liquid at a temperature of 60° C. or lower, such as, for example, 50° C. or lower, 40° C. or lower, 30° C. or lower, 10° C. or lower, or 0° C. or lower. The coating composition can be a liquid at a temperature in a range of −10° C. to 60° C., such as, for example, −10° C. to 50° C., −10° C. to 40° C., −10° C. to 30° C., or 0° C. to 40° C. The coating composition can be a liquid at ambient temperature.

A method for applying a coating system to a substrate comprises depositing the coating composition comprising the pigment according to the present disclosure over a substrate. The coating composition can be deposited by at least one of spray coating, spin coating, dip coating, roll coating, flow coating, and film coating. In various examples, the coating composition may be manufactured as a preformed film and thereafter applied to the substrate. After depositing the coating composition over the substrate, the coating composition may be allowed to coalesce to form a substantially continuous film on the substrate, and the coating composition can be cured to form a coating layer. The coating composition can be cured at a temperature of −10° C. or greater, such as, for example, 10° C. or greater. The coating composition can be cured at a temperature of 175° C. or lower, such as, for example, 100° C. or lower. The coating composition can be cured at a temperature in a range of −10° C. to 175° C. The curing can comprise a thermal bake in an oven.

The substrate can be at least partially coated with the coating composition comprising the pigment according to the present disclosure. For example, the coating composition can be applied to 5% or greater of an exterior surface area of the substrate, such as, for example, 10% or greater, 20% or greater, 50% or greater, 70% or greater, 90% or greater, or 99% or greater of an exterior surface area of the substrate. The coating composition comprising the pigment according to the present disclosure can be applied to 100% or lower of an exterior surface area of the substrate, such as, for example, 99% or lower, 90% or lower, 70% or lower, 50% or lower, 20% or lower, or 10% or lower of an exterior surface area of the substrate. The coating layer comprising the pigment according to the present disclosure can be applied to 5% to 100% of an exterior surface area of the substrate, such as, for example, 5% to 99%, 5% to 90%, 5% to 70%, or 50% to 100% of an exterior surface area of the substrate.

The dry film thickness of the coating layer and/or film comprising the pigment according to the present disclosure can be 0.2 microns or greater, such as, for example, 0.25 microns or greater, 2 microns or greater, 10 microns or greater, 20 microns or greater, 25 microns or greater, 50 microns or greater, or 130 microns or greater. The dry film thickness of a coating layer and/or film comprising the pigment according to the present disclosure can be 500 microns or less, such as, for example, 130 microns or less, 50 microns or less, 25 microns or less, 20 microns or less, 10 microns or less, 2 microns or less, or 0.25 microns or less. The dry film thickness of the coating layer and/or film comprising the pigment according to the present disclosure can be in a range of 0.2 microns to 500 microns, such as, for example, 10 microns to 500 microns, 5 microns to 100 microns, 0.25 microns to 130 microns, 2 microns to 50 microns, or 10 microns to 25 microns. The thickness of the coating and/or film can affect electromagnetic transmission through the coating and/or film. The dry film thickness of the coating and/or film can be measured using a coating thickness measuring tool, such as a FMP40C Dualscope (available from Fischer Technology, Inc.).

The coating layer comprising the pigment according to the present disclosure may be incorporated into a single-layer or a multilayer coating stack, such as a multilayer coating stack including at least two coating layers, a first coating layer and a second coating layer underneath at least a portion of the first coating layer. Additional layers, such as, for example, a pretreatment layer, an adhesion promoter layer, a basecoat layer, a mid-coat layer, a topcoat layer (e.g., clear coat, tinted clear coat), a primer layer (e.g., a non-conductive primer layer), or combinations thereof, may be deposited before or after the coating layer comprising the pigment according to the present disclosure. The tinted clear coat can be, for example, a clear coat to which dyes and or pigments are added, including the nano-sized pigment dispersions described in U.S. Pat. Nos. 6,875,800, 7,605,194, 7,612,124, and 7,981,505, all of which are hereby incorporated by reference herein. The tinted clear coat can comprise nano-sized pigment dispersions with an average primary particle size of less than 150 nm as measured with a TEM, such as, for example, less than 100 nm as measured with a TEM. The nano-sized pigment dispersions can have an average primary particle size in a range of 20 nm to 150 nm, such as, for example, 20 nm to 100 nm, 20 nm to 80 nm, 20 nm to 60 nm, or 20 nm to 40 nm. For example, the nano-sized pigments dispersions can have a particle size of 25 nm, 35 nm, or 50 nm.

A coating stack for use in automotive applications may comprise an adhesion promoter layer applied to a radar transmissive substrate, a primer layer disposed over the adhesion promoter layer, a basecoat layer comprising the pigment according to the present disclosure disposed over the primer layer, and a clear coat disposed over the basecoat layer. The primer layer may be referred to as basecoat 1 layer (B1) and can have a basecoat 2 layer (B2) applied thereover. The B2 layer can comprise the pigments according to the present disclosure.

The coating compositions and films of the present disclosure can be applied to various substrates in which radar transparency and metallic appearance may be desired. For example, the substrate upon which the coating composition and films of the present disclosure may be applied comprise an automotive substrate, an industrial substrate, an architectural substrate, a coil substrate, a packaging substrate, a marine substrate, an aerospace substrate, a consumer electronic device substrate (e.g., a phone, computer, tablet), or the like, or combinations thereof. “Automotive” as used herein refers to in its broadest sense all types of vehicles, such as, but not limited to, cars, trucks, buses, tractors, harvesters, heavy duty equipment, vans, golf carts, motorcycles, bicycles, railcars, airplanes, helicopters, boats of all sizes, and the like.

For example, the substrate can be a radar transmissive substrate. A “radar transmissive substrate” means a substrate having a composition and thickness suitable to transmit electromagnetic radiation at various radar frequencies (e.g., in the range of automotive frequencies of 76 GHz to 81 GHz) with minimal, if any, transmission loss. For example, a radar transmissive substrate can be transparent to the various radar frequencies. That is, a radar transmissive substrate can have a one-way radar transmission loss (OWRTL) of no greater than 5 dB as measured by the Radar Test described below. Radar transmissive substrates may be nonmetallic and include polymeric substrates, such as plastic, including polyester, polyolefin, polyamide, cellulosic, polystyrene, polyethylene terephthalate, polyacrylic, poly(ethylene naphthalate), polypropylene, polyethylene, nylon, ethylene vinyl alcohol, polylactic acid, other “green” polymeric substrates, poly(ethyleneterephthalate), polycarbonate, polycarbonate acrylobutadiene styrene, polyurethane, thermoplastic olefins, polyamide, or combinations thereof. The radar transmissive substrate may be filled or unfilled plastic. A filled plastic comprises a plastic with additives such as fibers, such as glass fibers, and/or particles, such as talc. The radar transmissive substrate can comprise glass, wood, or a combination thereof.

Articles of manufacture according to the present disclosure can similarly include vehicle parts, consumer electronic parts, and the like and can be directly printed, for example, by 3D printing or additive manufacturing, from a mixture comprising the pigments of the present disclosure. Such parts would be expected to have a sparkle or metallic luster while also facilitating radar transmission. For example, articles manufactured according to the present disclosure can comprise automotive bumper fascia.

A coating stack as applied to a radar transmissive substrate, such as, for example, in automotive refinish or aerospace applications, may comprise an optional pretreatment layer and/or adhesion promoter layer, a primer layer, a basecoat layer comprising the pigment according to the present disclosure, and a clear coat. A coating stack as applied to a radar transmissive substrate, such as, for example, in automotive refinish, general industrial, or aerospace applications, can comprise an optional pretreatment or adhesion promoter layer, a primer layer, and a direct gloss topcoat layer comprising the pigment according to the present disclosure. Direct gloss topcoat means a coating layer comprising both the color and gloss in one coating that is typically the last applied coating of a coating stack. An additional clear coat can be applied to a direct gloss coating.

A radar system may be positioned proximal to and/or adjacent to the coating, film, and/or article incorporating the pigment according to the present disclosure. The radar system can transmit electromagnetic waves that can traverse through the coating, film, and/or article incorporating the pigment according to the present disclosure. The coating, film, and/or article incorporating the pigment according to the present disclosure can minimally, if at all, reduce the transmission of the electromagnetic waves therethrough such that the electromagnetic radiation can exit the coating, film, and/or article. The electromagnetic radiation that exits the coating, film, and/or article can be used for the detection of an object. For example, the electromagnetic radiation can reflect off of the object and return through the coating, film, and/or article and be detected by the radar system.

A method for improving radio detection and ranging in the electromagnetic radiation frequency range of 1 GHz to 300 GHz with radar sensors that are mounted behind effect pigment containing articles is provided. The method comprises applying a coating composition and/or film comprising the pigment according to the present disclosure to a substrate and/or forming the substrate with the pigment according to the present disclosure incorporated therein. The improvement can be relative to an effect pigment containing article comprising a conductive pigment.

The pigments according to the present disclosure may also suitably be incorporated into a film that, when applied to an article, may provide a desirable optical property, including imparting a metallic luster across visible light wavelengths, and/or providing desirable radio frequency transparency, such as at automotive radar frequencies. The film comprising the pigments of the present disclosure can be formed from any material in which a film suitable for application to a substrate would result. Films according to the present disclosure may be made such that the film would have an appearance similar to a flake-containing coating with a “sparkle-like” quality, rather than a mirrored look. The “sparkle-like” quality evident in coatings containing reflective effect pigments can be evaluated as described in “Complete Appearance Control for Effect Paint Systems,” Paint & Coatings Industry, Mar. 8, 2020. Films can be applied to any substrate, as described below, and may be used in conjunction with another film layer or coating layer.

The film can be a multilayer film comprising at least two layers, including a first layer comprising a thermoset or thermoplastic layer comprising the pigment according to the present disclosure and an adhesive layer. The adhesive layer can be protected with a removable layer or release liner that would be removed prior to application of the film to a substrate. The first layer may be applied to a carrier film that would support the first layer until the first layer is formed, and thereafter the carrier film may optionally be removed. The first layer may be applied to protective clear film that itself may be on a carrier film. The protective clear film may be thermoset or thermoplastic and would be the top layer when the multilayer film is applied to a substrate via contact of the adhesive layer with the substrate. A layer of the multilayer film may comprise thermoset or thermoplastic polyurethane. Examples of such multilayer films and the process of making such films are described in U.S. Patent Publication No. 2011/0137006, U.S. Patent Publication No. 2017/0058151, U.S. Patent Publication No. 2014/322529, U.S. Patent Publication No. 2004/0039106, U.S. Patent Publication No. 2009/0186198, U.S. Patent Publication No. 2010/0059167, U.S. Patent Publication No. 2019/0161646, U.S. Pat. Nos. 5,242,751, and 5,468,532, all of which are hereby incorporated by reference. The films of these references can be improved with the incorporation of the pigment according to the present disclosure into a layer of the multilayer film. The first layer of the film may be spray applied, extruded, formed, or polymerized in situ, or otherwise deposited to an adjacent layer of a multilayer film or to a removable layer.

The pigments according to the present disclosure may also be suitably incorporated into an article of manufacture, such as, for example, an article formed by injection molding, or an additive manufacturing process, such as, for example, a 3D printing process. In this manner, automotive parts, aerospace parts, consumer electronic parts, and the like can be directly printed from a mixture comprising the pigments of the present disclosure. Such parts would be expected to have a “sparkle-like” or metallic appearance while also facilitating radar transmission. For example, an automotive part can comprise bumper fascia, mirror housings, a fender, a hood, a trunk, a door, and the like. Aerospace parts can comprise a nose cone and a radome.

In-mold coating (IMC) is an alternative to painting for injection molded plastic parts. IMC can be done by injecting a coating composition according to the present disclosure onto the surface of the article of manufacture while it is still in the mold. The coating then solidifies and adheres to the article. A coating composition or film according to the present disclosure can be applied in mold prior to injection molding of an article of manufacture such that the coating or film is applied to the surface of the molded article or manufacture. Both methods are IMC according to the present disclosure.

When used in injection molding or additive manufacturing in which a part is fabricated by extrusion, the pigment according to the present disclosure may be incorporated into the bulk of the material forming the extrusion; can be incorporated into a layer of the extrusion, such as a surface layer of the extrusion using coextrusion methods; or can be applied to the extrudate by spraying or brushing the pigment onto at least a portion of the exterior surface of the extrudate during fabrication of the part or after the part is fabricated. In a 3D printing coextrusion method, a material containing a pigment according to the present disclosure can be combined with a substrate material in a coextrusion die such that the pigment-containing material forms a layer containing the pigment on the exterior surface of the part. The material forming the substrate and the pigment-containing layer can be coreactive such that compounds within the two layers coreact to form a robust interface. Forming a pigment-containing exterior layer by coextrusion also can avoid having to perform coating or painting processes after the part is fabricated.

Materials and methods using ambient coreactive reactive 3D printing are disclosed, for example, in International Publication No. PCT/US2020/017464, filed on Feb. 10, 2020, and entitled Coreactive Three Dimensional Printing of Parts; PCT/US2020/017428, filed on Feb. 10, 2020, and entitled Multilayer Systems and Methods of Making Multilayer Systems; and PCT/US2020/017417, filed on Feb. 10, 2020, and entitled Methods of Making Chemically Resistant Sealants, each of which is hereby incorporated by reference herein, where the extrusion materials of these references can include a pigment according to the present disclosure.

The coating compositions and films according to the present disclosure, when coated on substrates to form a coating layer or applied to substrates as a film, may result in substrates having favorable radar transmission performance and desirable aesthetics. The pigments of the present disclosure, when incorporated into an article of manufacture, may have similar performance and aesthetics.

A coating and/or film, when applied to a substrate and an article incorporating the pigment according to the present disclosure can comprise a desirable metallic luster as indicated by a L₁₅ value as measured by the Near-Specular Lightness Test and the flop index as measured by the Flop Test. Additionally, a coating and/or film, when applied to a substrate and an article incorporating the pigment according to the present disclosure can provide a desirable radar transparency as indicated by one way RADAR transmission loss (OWRTL) as measured by the Radar Test in a radar range of 76 GHz to 81 GHz. In various examples, a coating and/or film, when applied to a substrate and an article incorporating the pigment according to the present disclosure can provide a desirable opacity as measured by the Opacity Test such that the coating, film, and/or article is hiding layers underneath.

The Near-Specular Lightness Test quantifies the reflectance of a coating, film, and/or article using the International Commission on Illumination (CIE) L₁₅ value as discussed here. CIE L*a*b* color values can be measured using a multi-angle spectrophotometer, such as a BYKmac I, from Altana, at the measurement angles of 15°, 25°, 45°, 75°, and/or 110° relative to the specular direction, with D65 illumination and 10° observer. The L* lightness values at the measurement angle of 15° will be referred to as Lis, at the measurement angle of 25° will be referred to as L₂₅, at the measurement angle of 45° will be referred to as L₄₅, at the measurement angle of 75° will be referred to as L₇₅, and at the measurement angle of 110° will be referred to as L₁₁₀.

A coating, film, and/or article incorporating the pigment according to the present disclosure can have a desirable metallic luster. For example, a coating, film, and/or article incorporating the pigment according to the present disclosure can comprise an Lis value of at least 50 as measured by the Near Specular Lightness Test, such as, for example, at least 60, at least 70, at least 80, at least 90, at least 100, at least 110, at least 120, at least 130, at least 140, at least 150, or at least 160, all as measured by the Near Specular Lightness Test.

The alignment of the pigment is generally acknowledged to affect the lightness value, L*, at 15° and the flop index of a coating, film, and/or article as measured using a multiangle spectrophotometer, such as a BYKmac I spectrophotometer according to the Flop Test. The flop index of a coating, film, and/or article incorporated the pigment according to the present disclosure can be at least 4 as measured according to the Flop Test, such as, for example, at least 5, at least 6, at least 8, at least 10, at least 12, at least 15, at least 17, at least 19, or at least 21, all as measured according to the Flop Test.

The flop index of the coating or film on a substrate or the article can be determined using the Flop Test. The Flop Test can quantified the flop index from the L* values using the CIE L*a*b* color space measured using a multi-angle spectrophotometer, such as a BYKmac I spectrophotometer, with D65 illumination and 10° observer. As used herein, the term “flop index” is defined according to “Observation and Measurement of the Appearance of Metallic Materials—Part 1—Macro Appearance,” C. S. McCamy, Color Research And Application, Volume 21, Number 4, August 1996, pp. 292-304, which is hereby incorporated by reference. Namely, the flop index is defined according to Equation 1, set forth below.

Flop Index=2.69(L₁₅−L₁₁₀)^{1.11}/(L₄₅)^{0.86} Equation 1

wherein:
L₁₅ is CIE L* value measured at the aspecular angle of 15°;
L₄₅ is CIE L* value measured at the aspecular angle of 45°; and
L₁₁₀ is CIE L* value measured at the aspecular angle of 110°.

OWRTL can quantify the radar loss, if any, of a coating, film, and/or article incorporating the pigment according to the present disclosure. OWRTL can be measured in dB according to the Radar Test using a radar transmission system, such as a focused beam radar measurement system assembled from the following components: a signal generator (SMA100B (with SMAB-B92/SMAB-B120)) available from Rohde & Schwarz, a six times multiplier (SMZ90) available from Rohde & Schwarz, a thermal waveguide power sensor (NRP90TWG) available from Rohde & Schwarz, two E-band spot-focusing lens antennas with 1.7 inch focal length (SAQ-813017-12-S1) available from Sage Millimeter, and a Coax cable, 3.5 mm Male to 3.5 mm Male (FM160FLEX) available from Fairview Microwave. The two lenses are connected to the emitter (six times multiplier) and the detector (the power sensor), with the lenses facing each other. The lenses are aligned along their axis, with their separation being about twice their focal length (3.4 inches) and with this separation adjusted to ensure maximum free space radar transmission, with no sample between the lenses. Then, with this setup, a sample may be measured by securing it between the lenses, with the surface of the sample that is facing the detecting lens being placed at a distance of 45 mm from the detecting lens (1.8 mm in front of the focal point of the detecting lens). If the sample is a thermoplastic polyolefin (TPO) panel having a coating or film thereon, the OWRTL may be measured by securing it between the lenses, with the surface of the coating or film that is being measured placed facing the detecting lens, at a distance of 45 mm from the detecting lens. The radar transmission loss in dB is calculated with Equation 2.

OWRTL (dB)=free space transmission (dBm)−sample transmission (dBm). Equation 2:

A coating, film, and/or article incorporating the pigment according to the present disclosure can comprise a desirable radar transparency. For example, a coating, film, and/or article incorporating a pigment according to the present disclosure can comprise an OWRTL of no greater than 1.5 dB as measured by the Radar Test in the frequency range of 76 GHz to 81 GHz, such as, for example, no greater than 1.3 dB, no greater than 1.0 dB, no greater than 0.7 dB, no greater than 0.5 dB, or no greater than 0.3 dB, all as measured by the Radar Test.

The visual opacity can be measured according to the Opacity Test. The Opacity Test comprises applying a coating and/or film onto a standard panel for measuring the hiding power of a coating and/or film (i.e., Form T12G METOPAC™ Panel, 3×5× 3/16 inch, available from from Leneta Company, Inc. Mahwah, New Jersey). The standard panel has a black portion with L* of 26 (+/−5%) and a white portion having a L* of 94 (+/−5%) measured with an integrating sphere spectrophotometer, such as an X-Rite Ci7800, with D65 illumination, 10° observer, and SCI. In examples comprising an article, the standard panel can be placed behind the article and adjacent to the article. After coating the panel with a coating and/or film to be measured for opacity, the CIE lightness value, L*, is measured over the black and white portions of the standard panel with an integrating sphere spectrophotometer, such as an X-Rite Ci7800, with D65 illumination, 10° observer, and SCI. A ratio of the L* values measured over the black and white portions of the coated standard panel is then determined, which quantifies the opacity of the coating and/or film. The equation for the percent opacity is shown in Equation 3.

Opacity (%)=L*(over the black portion of the panel)/L*(over the white portion of the panel)*100. Equation 3:

The dry film thickness selected should be the same used in the Opacity Test, the Near Specular Lightness Test, the Flop Test, and the Radar test. The dry film thickness (DFT) of the coating and/or film in the Opacity Test, the Near Specular Lightness Test, the Flop Test, and the Radar test is in the range of 0.2-4.0 mils (5-100 microns). The thickness of the article in the Opacity Test, the Near Specular Lightness Test, the Flop Test, and the Radar test can be in a range of 0.2-4 mils (5-100 microns). The dry film thickness can be chosen to provide the desired opacity and the desired radar transmission. For example, increasing the dry film thickness can increase the opacity, however increasing the dry film thickness can also increase the OWRTL.

A coating, film, and/or article incorporating the pigment according to the present disclosure can comprise a visual opacity of at least 90% opacity as measured by the Opacity Test, such as, for example, at least 92%, at least 95%, at least 97%, or at least 99% as measured by the Opacity Test. The pigment according to the present disclosure can provide desirable visual opacity while maintaining a desired level of radar transparency.

A coating and/or film, when applied to a substrate, and an article incorporating the pigment according to the present disclosure can comprise:
an L₁₅ value of at least 120 as measured by the Near-Specular Lightness Test;
a flop index of at least 10 as measured by the Flop Test;
OWRTL of no greater than 1.5 dB as measured by the Radar Test in a radar range of 76 GHz to 81 GHz; and
at least 90% opacity as measured by the Opacity Test.

As used herein, unless otherwise expressly specified, all numbers, such as those expressing values, ranges, amounts, or percentages, may be read as if prefaced by the word “about,” even if the term does not expressly appear. Any numerical range recited herein is intended to include all sub-ranges subsumed therein. The plural encompasses the singular and vice versa. For example, while the invention has been described in terms of “a” pigment, “a” substrate, “a” MSCD composite layer, “a” metal, “a” semiconductor, “a” dielectric, and the like, more than one of these and other components, including mixtures, can be used. Also, as used herein, the term “polymer” is meant to refer to prepolymers, oligomers, and both homopolymers and copolymers; and the prefix “poly” refers to two or more. When ranges are given, any endpoints of those ranges and/or numbers within those ranges can be combined with the scope of the present invention. “Including,” “such as,” “for example,” and like terms mean “including/such as/for example but not limited to.” The terms “acrylic” and “acrylate” are used interchangeably (unless to do so would alter the intended meaning) and include acrylic acids, anhydrides, and derivatives thereof, lower alkyl-substituted acrylic acids, e.g., C₁-C₂ substituted acrylic acids, such as methacrylic acid, ethacrylic acid, etc., and their C₁-C₆ alkyl esters and hydroxyalkyl esters, unless clearly indicated otherwise.

As used herein, the terms “on,” “applied on/over,” “formed on/over,” “deposited on/over,” “overlay,” and “provided on/over” mean formed, overlay, deposited, or provided on but not necessarily in contact with the surface. For example, a coating layer “formed over” a substrate does not preclude the presence of one or more other coating layers of the same or different composition located between the formed coating layer and the substrate.

As used in this specification, the terms “cure” and “curing” refer to the chemical crosslinking of components in a coating composition applied as a coating layer over a substrate. Accordingly, the terms “cure” and “curing” do not encompass solely physical drying of coating compositions through solvent or carrier evaporation. In this regard, the term “cured,” as used in this specification, refers to the condition of a coating layer in which a component of the coating composition forming the layer has chemically reacted to form new covalent bonds in the coating layer (e.g., new covalent bonds formed between a binder resin and a curing agent).

As used in this specification, the term “formed” refers to the creation of an object from a composition by a suitable process, such as, curing. For example, a coating formed from a curable coating composition refers to the creation of a single or multiple layered coating or coated article from the curable coating composition by curing the coating composition under suitable process conditions.

### EXAMPLES

The present disclosure will be more fully understood by reference to the following examples, which provide illustrative non-limiting aspects of the invention. It is understood that the invention described in this specification is not necessarily limited to the examples described in this section.

As used herein, the term “parts” refers to parts by weight unless indicated to the contrary.

Test Methods

Panel Coating Method: Coatings formulated as described herein were sprayed in one or more coats to a dry film thickness (DFT) of 0.1-4.0 mils (8-100 microns) onto a TPO panel (Lyondell Basell HiFax TRC779X, 4 inches×12 inches×0.118 inch, available from Standard Plaque Inc.) as well as onto a black/white Metopac panel (3×5× 3/16 inch, Form T12G, from Leneta Company), as needed when measuring opacity. Prior to spraying the formulated coatings, the TPO panel was cleaned with SU4901 Clean and Scuff Pad, wiped with SU4902 Plastic Adhesion Wipe, and sprayed with SUA4903 Advanced Plastic Bond (all available from PPG Industries, Inc.). Once the SUA4903 was dry (approximately 5-15 min after application) a sealer (DAS3025/DCX3030/DT885 mixed at 3/1/1 by volume, Acrylic Urethane Sealer/Undercoat Hardener/Warm Temperature Reducer, all available from PPG Industries, Inc.) was applied in one coat with a SATAjet BF100 spray gun with a 1.3 mm nozzle and 28 psi air pressure at the gun. The sealer was allowed to dry and cure for 15-60 min before the formulated coatings of the examples herein were applied. The example coating mixture was agitated prior to spray application by stirring. A high volume lower pressure (HVLP) gravity fed spray gun (SATAjet 1500 B HVLP SoLV) with a 1.3 mm nozzle and 28 psi air pressure at the gun was used to spray apply the coatings with flash between multiple coats for 5-10 minutes and would be considered dry when the coatings were tack free (typically 15-40 minutes at 20° C.). The panel was then coated with a protective clearcoat. PPG DELTRON solvent borne clearcoat (Velocity Premium Clearcoat; DC 4000, available from PPG Industries, Inc.) was prepared by mixing DC 4000 with hardener (DCH 3085) in a 4:1 v/v ratio. Clearcoats were applied in two coats over tack-free coating layers of the examples of the present invention using a HVLP gravity fed spray gun (Anest Iwata WS400) with a 1.3 mm nozzle and 28 psi at the gun. Clearcoats were applied using two coats with a 5-10 minute flash at ambient temperature between coats. Clearcoats were cured as described in the publically available technical data sheet, such as in a convection oven at 60° C. for 20 minutes or at 21° C. for 4-6 hours. All dry film thicknesses (DFT) were measured by spraying 0.020×2×12 inch steel film check panels (available from Q-Lab Corporation, Westlake, Ohio, Order Number SP-105293) at the same time as the other panels and using a coating thickness measuring tool, such as a FMP40C Dualscope (available from Fischer Technology, Inc.), to measure the cured coating thickness on the film check panels.

Top-Down Field Emission-Scanning Electron Microscopy (FE-SEM): Films were delaminated from the substrate by freeze fracturing, in which a small section of the panel was submerged in liquid N2 for 20 seconds and then bent with pliers until the coating was removed from the substrate. Samples were then coated with Au/Pd for 40 seconds and analyzed in the Quanta 250 FEG SEM under high vacuum using an Everhart-Thornley detector (ETD). The accelerating voltage was set to 10.00 or 5.00 kV and the spot size setting of 3.0.

### Example 1: Platelet Pigment 1

12 cm×12 cm PMMA/PC (poly(methyl methacrylate)/Polycarbonate) plastic substrate with a polyethylene film on both sides was cleaned by wiping with isopropyl alcohol and then coated with a clear UV cured primer coating (VMPX00007, multifunctional acrylate based coating commercially available from PPG China) by spray application using an Anest Iwata W-101 spray gun at 4 kgf/cm² (57 psi) to apply 4 coats. The applied coating was dried at 60° C. for 5 minutes and then exposed to UV light with a 550 mm long 3.2 kW mercury lamp with a 105 mW/cm² irradiance to a dose of 800 mJ/cm². This resulted in a cured film of 7-10 microns thick. Ten coated panels were then vacuum metallized in a ZHL900 single door evaporation coating machine (Guangdong Zhenhua Technology Co., Ltd.) with the following process settings: preheat time of 20 seconds, preheating voltage of 1.6V, pre-melting time of 12 seconds, pre-melting keep of 10 seconds, pre-melting voltage of 2V, evaporation time of 5 seconds, evaporation keep time of 25 seconds, evaporation voltage 2.5V using about 1.2 g of indium in the form of 2 cm long 1 mm diameter rods. Multiple batches of the vacuum metallization process were carried out to yield the desired number of vacuum metallized films.

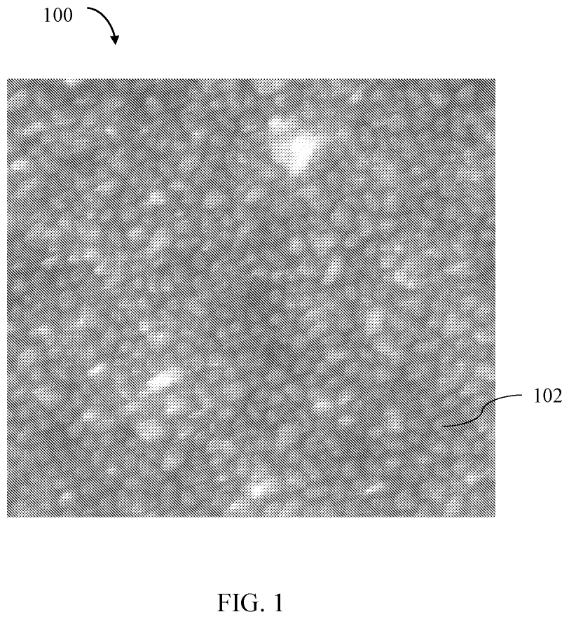

As illustrated in FIG. 1, the metallized films demonstrated a discontinuous island morphology where discrete particles of indium 102 were deposited on clear UV cured primer coating such that they formed a non-conductive composite film 100. As observed, the discrete particles of indium 102 are formed on the clear UV cured primer and separated by air. This was observed by SEM using the top-down FE-SEM method.

The resultant films had a metallic luster and the optical qualities of the films were measured using an X-Rite Ci7800 set to D65 illuminant and 10 degree observer in reflectance mode. Both SCI and SCE mode were recorded. At least three samples were measured and averaged. An average specular reflectance of 71.6% was measured according to the Visible Reflectance Test. Resistivity of the film according to a four-point probe was also measured. The results are reported in Table 1 below.

TABLE 1
Optical Properties and Resistivity of the Film
prior to removal from the substrate and milling

| Film Measurements | Value |
|---|---|
| Ave % R SCI 400-700 nm | 74.2 |
| Ave % R SCE 400-700 nm | 2.6 |
| Ave Spec % R | 71.6 |
| Resistivity | >60 Ωcm |

The combined UV coating and Indium was removed from the polyethylene film using a razor blade scraper and a vacuum cleaner (Metrovac 500, model VM500) with a small bag filter (DataVac Disposable 2 ply filter bag, part number DVP-26RP) to collect the removed material. The removed films were milled with a Strand mill (large lab grinder, model S102DS, Strand Manufacturing Company, Inc.) for 60 seconds, turning the film into small flakes. The flakes were then passed through a 600 micron and 300 micron sieve (Fischer Scientific, catalog numbers 04-881-10P and 04-881-10T respectively) to remove any large particles. The average lateral size of the pigment flake according to the Lateral Size test was measured to be 49.5 microns and the average thickness was measured to be 9.7 microns according to the Thickness test. The aspect ratio was 5.1

### Example 2: Platelet Pigment 2

12 cm×12 cm PMMA/PC (poly(methyl methacrylate)/Polycarbonate) plastic substrate with a polyethylene film on both sides was cleaned by wiping with isopropyl alcohol and then coated with a lacquer, WATCO Clear Gloss Lacquer (product number 63014 available from Rust-Oleum Corp.) with 2 wt % on solution of K-Sperse 131 (available from King Industries, Inc.) by spray application using a high volume low pressure (HVLP) gravity fed spray gun (Anest Iwata WS400) with a 1.3 mm nozzle and 28 psi at the gun. The clear gloss lacquer was applied in two coats with a flash between coats until the first applied coat was visually dry. The panels with applied lacquer coating were then sent for application of an 85/15 w/w Si/Al non-conductive composite layer following similar conditions as Tung et. al. from Materials Letters 131 (2014) 161-163 incorporated herein by reference and with the sputtering conditions of a base pressure of 3.5×10\hat{ }-6 torr, working pressure of 3.5×10\hat{ }-3 torr, and sputtering power of 5.5 kW.

The resultant films had a metallic luster. The optical qualities of the films were measured according to the Visible Reflectance Test and the resistivity was measured using a four-point probe of the films. The results of these properties are reported in Table 2 below:

TABLE 2
Optical Properties and Resistivity of
the Film prior to Removal and Milling

| Film Measurements | Value |
|---|---|
| Ave % R SCI 400-700 nm | 47.4 |
| Ave % R SCE 400-700 nm | 2.5 |
| Ave Spec % R | 44.9 |
| Resistivity | 3.4 Ωcm |

The resultant Si/Al layer was removed from the substrates with a vacuum cleaner (Metrovac 500, model VM500) with a small bag filter (DataVac Disposable 2 ply filter bag, part number DVP-26RP. The collected material was placed into a jar and n-butyl acetate solvent was added to obtain a 13.74w % total solids (non-volatile) mixture. The flakes were milled simply by hand shaking for about two minutes in the solvent. The mixture was then poured through a filter that consisted of two nylon mesh filters with a 280 micron pore size stacked together along with a layer of Kimwipe towel. The flakes in the filter were further rinsed with n-butyl acetate to remove the lacquer release layer, the flakes were then placed in a jar and n-butyl acetate was added. The jar was then allowed to sit overnight allowing the flakes to settle. A pipette was used to remove as much clear solvent as possible without removing any flakes. The mixture was then allowed to sit again overnight and the clear solvent layer removed with a pipette. The final wt % solids (non-volatile) content was measured by placing 1 drop of the mixture on the white portion of a substrate while on a balance so that the drop weight was known. Then the drop was then spread out by rotating and tapping the substrate. Then a photograph was taken of the dried flakes on the substrate black/white Metopac panel (3×5× 3/16 inch, Form T12G, from Leneta Company). The resultant pigment in solvent dispersion was 0.55 wt % solids (non-volatile). The average lateral size of the pigment flake according to the Lateral Size test was measured to be 23 microns and the average thickness was measured according to the Thickness test to 59 nm. The aspect ratio was 390.

### Prophetic Example 3: Platelet Pigment 3

It is believed that a Si/Al flake pigment can be made according to the methods of Example 2, with the Si/Al concentration in the range of 85 wt % Si and 15 wt % Al to 75 wt % Si and 25 wt % Al. The expected optical properties and resistivity of the film prior to removal from the substrate and milling into flakes are shown in Table 3.

TABLE 3
Expected Optical Properties and Resistivity of the Film
prior to removal from the substrate and milling

| Film Measurements | Value |
|---|---|
| Ave % R SCI 400-700 nm | >75 |
| Ave % R SCE 400-700 nm | >3 |
| Ave Spec % R | >72 |
| Resistivity | >60 Ωcm |

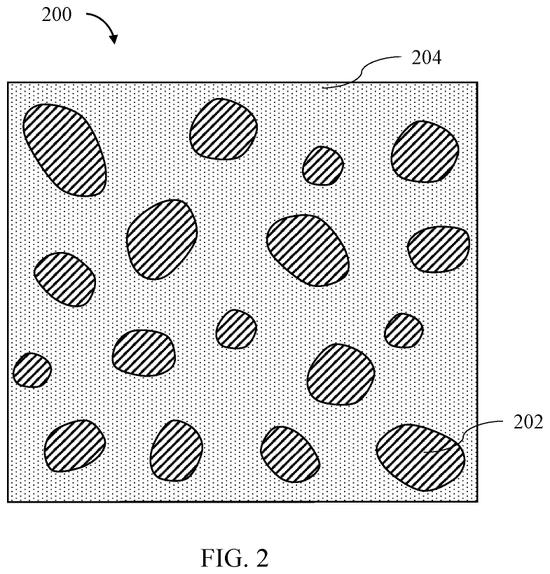

It is believed that the pigment created in Example 3 would have a structure as illustrated in FIG. 2. Namely, the non-conductive composite 200 would have aluminum particles 202 dispersed within the silicon matrix 204.

### Example 4: Coating Composition

The pigment of Example 1 (7.53 g) was incorporated into 23.87 g DBC500 (DELTRON Color Blender, solvent borne film-forming composition comprising polyacrylate and cellulose acetate butyrate, available from PPG Industries, Inc.) and 28.8 g of reducer DT885 (solvent blend available from PPG Industries, Inc.) by adding all components to a jar and shaking by hand for 1-5 minutes. The pigment was at a pigment volume concentration of 50 volume % based on the volume of the non-volatile components of the coating. The formulated coating composition was stirred by hand prior to spray application using the Panel Coating Method. The panel was evaluated for various properties as reported in Table 4 below.

TABLE 4
Properties of coated panel

| | | | | Opacity | Average | L₁₅ according | Flop |
|---|---|---|---|---|---|---|---|
| SU4902/ | | Example | | according | OWRTL | to the Near- | Index |
| SUA4903 | Sealer | 3 DFT | Clearcoat | to the | according to | Specular | according |
| DFT (mil | DFT (mil | (mil | DFT (mil | Opacity | the Radar | Lightness | to the |
| [micron]) | [micron]) | [micron]) | [micron]) | Test (%) | Test (dB) | Test | Flop Test |
| 0.06 [1.5] | 1.21 | 2.53 | 2.85 | 98.6 | 1.28 | 58.07 | 4.87 |
| | [30.7] | [64.3] | [72.4] | | | | |

### Prophetic Example 5: Prophetic Coating Composition Containing Platelet Pigment 3

The pigment of Example 3 can be incorporated into DBC500, an automotive refinish solventborne polyacrylate based coating from PPG Industries, Inc., with a mixing blade at a pigment volume concentration in the range of 7-50% based on the volume of the of the non-volatile components of the coating. A reducer such as DT870, solvent blend available from PPG Industries, Inc., would be added at a 1:1 volume ratio to the amount of DBC500 and stirred by hand prior to application. The coating would then be applied using the Panel Coating Method.

The following properties of the applied coatings would be anticipated as shown in Table 5:

TABLE 5
Expected Properties of coated Panel

| | Average | L₁₅ | |
|---|---|---|---|
| Opacity | OWRTL | according to | |
| according to | according to | the Near- | Flop Index |
| the Opacity | the Radar | Specular | according to |
| Test (%) | Test (dB) | Lightness Test | the Flop Test |
| ≥90% | ≤1.5 dB | ≥120 | ≥10 |

### Example 6: Comparative Coating Composition

9.31 g of ALPASTE TCR 3040 aluminum paste (available from Toyo Aluminum K.K.) was stirred into 121.71 g of DBC500, an automotive refinish solvent-borne polyacrylate based coating from PPG Industries, Inc. A reducer, DT870, solvent blend available from PPG Industries, Inc., was added at a 1:1 volume ratio to the amount of DBC500 and stirred by hand prior to application. The resultant coating had 11.1% pigment volume concentration of aluminum flake based on the volume of the non-volatile components of the coating. The coating was then applied according to the Panel Coating Method.

The following properties of the applied coatings were observed as shown in Table 6 below:

TABLE 6
Properties of Comparative Coated Panel

| | | | | | Average | L₁₅ | |
|---|---|---|---|---|---|---|---|
| | | | | | OWRTL | according | Flop |
| | | | | Opacity | according | to the | Index |
| SU4902/ | Sealer | Example | | according | to the | Near- | according |
| SUA4903 | DFT | 6 DFT | Clearcoat | to the | Radar | Specular | to the |
| DFT (mil | (mil | (mil | DFT (mil | Opacity | Test | Lightness | Flop |
| [micron]) | [micron]) | [micron]) | [micron]) | Test (%) | (dB) | Test | Test |
| 0.05 [1.3] | 0.85 | 0.75 | 2.50 | 99.5% | 1.78dB | 147.95 | 18.55 |
| | [21.6] | [19.1] | [63.5] | | | | |

As can be seen from the above examples the pigment according to the present disclosure and coatings comprising the pigments according to the present disclosure can approximate the appearance of an aluminum pigment while also improving the OWRTL.

Notwithstanding that the numerical ranges and parameters setting forth the broad scope of the invention are approximations, numerical values set forth in the specific examples are reported as precisely as possible. Any numerical value, however, inherently contains certain errors necessarily resulting from the standard variation found in their respective testing measurements.

Whereas particular examples of this invention have been described above for purposes of illustration, it will be evident to those skilled in the art that numerous variations of the details of the present invention may be made without departing from the invention as defined in the appended claims.

The term “average” as used herein means a “mean” of any variable, x, such as wavelength, diameter, lateral size, thickness, and so forth, is calculated by the equation: average=(1/N)Σxᵢ, where N values of the variable x are being averaged, such that i=1 to N, and Σxᵢ=x₁+x₂+ . . . +x_{N}, as discussed in Data Reduction and Error Analysis for the Physical Sciences, 2^{nd} edition, 1992, pages, 8-9, by Philip R. Bevington and D. Keith Robinson, ISBN 0-07-911243-9.

Various features and characteristics are described in this specification to provide an understanding of the composition, structure, production, function, and/or operation of the invention, which includes the disclosed compositions, coatings, and methods. It is understood that the various features and characteristics of the invention described in this specification can be combined in any suitable manner, regardless of whether such features and characteristics are expressly described in combination in this specification. The Inventors and the Applicant expressly intend such combinations of features and characteristics to be included within the scope of the invention described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

1. A pigment comprising:
a non-conductive composite comprising:
a semiconductor and/or a dielectric, and
a metal dispersed in and/or on the semiconductor and/or dielectric,
wherein the pigment has an aspect ratio of at least 5, wherein the aspect ratio is an average lateral size of the pigment divided by an average thickness of the pigment.

2. The pigment of claim 1, wherein the non-conductive composite is formed from a non-homogenous mixture.

3. The pigment of claim 1, wherein the metal is present in an amount of 1 wt % to 50 wt % based on the total weight of the non-conductive composite.

4. The pigment of claim 1, wherein the pigment has an average reflectance of at least 60% across a visible wavelength range of 400 nm to 700 nm as measured using an integrating sphere spectrophotometer averaging the reflectance values over the visible wavelength range of 400 to 700 nm for both the specular component included (SCI) mode and the specular excluded (SCE) mode, and then subtracting the average reflectance in the SCE mode from the average reflectance in the SCI mode.

5. The pigment of claim 1, wherein the metal has an average particle size in a range of 0.5 nm to 100 nm as measured by transmission electron microscopy, and/or the metal is dispersed in an organic, inorganic, or organic-inorganic hybrid material.

6. The pigment of claim 1, wherein the pigment has an average thickness in a range of 1 nm to 20 microns as measured with a transmission electron microscope for a thickness of less than 5 microns or an optical microscope for a thickness of at least 5 microns, and/or an average lateral size in a range of 5 microns to 150 microns, as measured with an optical microscope.

7. The pigment of claim 1, wherein the metal comprises aluminum, silver, copper, indium, tin, nickel, titanium, gold, iron, an alloy of any thereof, or combinations thereof.

8. The pigment of claim 1, wherein the non-conductive composite comprises a semiconductor comprising silicon, germanium, silicon carbide, boron nitride, aluminum nitride, gallium nitride, silicon nitride, gallium arsenide, indium phosphide, indium nitride, indium arsenide, indium antimonide, zinc oxide, zinc sulfide, zinc telluride, tin sulfide, bismuth sulfide, nickel oxide, boron phosphide, titanium dioxide, barium titanate, iron oxide, doped versions thereof, alloys thereof, or combinations thereof, such as, silicon.

9. The pigment of claim 1, wherein the non-conductive composite comprises a dielectric comprising solid insulator materials, ceramics, glass, organic materials, doped versions thereof, or combinations thereof.

10. The pigment of claim 1, wherein the semiconductor and/or dielectric is resistant to melting.

11. The pigment of claim 1, wherein the semiconductor and/or dielectric to metal weight ratio in the non-conductive composition is in a range of 1:1 to 9:1.

12. The pigment of claim 1, wherein the non-conductive composite has a resistivity of at least 1 Ohm cm as measured according to a four-point probe at ambient temperature.

13. The pigment of claim 1, wherein the pigment has or is made to have surface functionality that imparts a property to the pigment.

14. The pigment of claim 1, wherein the non-conductive composite does not comprise a thermoplastic resin nor a material that is predominantly amorphous carbon.

15. A method of making the pigment of claim 1, the method comprising:
depositing the metal and semiconductor and/or dielectric utilizing sputtering onto a support to form a non-conductive composite layer;
mixing the metal and the semiconductor and/or dielectric to form the non-conductive composite layer; and/or
depositing the semiconductor and/or dielectric to form a first layer and adding the metal to the first layer to form the conductive composite layer.

16. The method of claim 15, wherein the metal is added to the first layer in a predetermined pattern as non-continuous layer.

17. The method of claim 15, wherein the metal is added to the first layer as a continuous layer.

18. The method of claim 15, wherein the non-conductive composite is deposited directly onto the support, a release layer that has been applied to the support, or a soluble film.

19. The method of claim 18, wherein, after depositing the non-conductive support onto a release layer or a soluble film, the release layer or soluble film is dissolved by treatment or immersion in solvent, thereby releasing the non-conductive composite from the support.

20. The method of claim 15, further comprising processing the non-conductive composite to an average lateral size in a range of 5 microns to 150 microns as measured with an optical microscope.

21. A coating composition comprising:
the pigment of claim 1; and
a film-forming resin.

22. (canceled)

23. A film comprising the pigment of claim 1.

24. A coating layer comprising the pigment of claim 1 or a film comprising the pigment of claim 1, when applied to a substrate, wherein the coating layer or film comprises:
a. an L₁₅ value of at least 50 as measured using a multi-angle spectrophotometer at the measurement angle of 15° relative to the specular direction, with D65 illumination and 10° observer;
b. a flop index of at least 4 as measured using a multi-angle spectrophotometer, with D65 illumination and 10° observer according to the following equation:
Flop Index=2.69(L₁₅−L₁₁₀)^{1.11}/(L₄₅)^{0.86}
wherein:
L₁₅ is CIE L* value measured at the aspecular angle of 15°;
L₄₅ is CIE L* value measured at the aspecular angle of 45°; and
L₁₁₀ is CIE L* value measured at the aspecular angle of 110°;
c. one-way radar transmission loss of no greater than 1.5 dB as measured using a radar transmission system at a wavelength in a range of 76 GHz to 81 GHz; and
d. at least 90% opacity as measured using an integrating sphere spectrophotometer with D65 illumination, observer, and specular component included.

25. An article comprising:
the pigment of claim 1;
a coating layer comprising the pigment of claim 1; and/or
a film comprising the pigment of claim 1.

26. (canceled)

27. The article of claim 25, wherein the article comprises:
a. an L₁₅ value of at least 50 as measured using a multi-angle spectrophotometer at the measurement angle of 15° relative to the specular direction, with D65 illumination and 10° observer;
b. a flop index of at least 4 as measured using a multi-angle spectrophotometer, with D65 illumination and 10° observer according to the following equation:
Flop Index=2.69(L₁₅−L₁₁₀)^{1.11}/(L₄₅)^{0.86}
wherein:
L₁₅ is CIE L* value measured at the aspecular angle of 15°;
L₄₅ is CIE L* value measured at the aspecular angle of 45°; and
L₁₁₀ is CIE L* value measured at the aspecular angle of 110°;
c. one-way radar transmission loss of no greater than 1.5 dB as measured using a radar transmission system at a wavelength in a range of 76 GHz to 81 GHz; and
d. at least 90% opacity as measured using an integrating sphere spectrophotometer with D65 illumination, observer, and specular component included.

28. A substrate coated or covered at least in part with a coating composition comprising the pigment of claim 1 or a film comprising the pigment of claim 1.

29. (canceled)

30. (canceled)

31. (canceled)

32. A method for improving radio detection and ranging in an electromagnetic radiation frequency range of 1 GHz to 300 GHz with automotive radar sensors that are mounted behind metallic effect-coated articles, the method comprising:
applying a coating composition and/or film comprising the pigment of claim 1 to an automotive substrate; and/or
forming the automotive substrate with the pigment of claim 1 incorporated therein.
